(19) United States
(12) Patent Application Publication
(10) Pub. No.: US 2018/0220363 A1
(43) Pub. Date: Aug. 2, 2018

(54) A Wireless Device, a Radio Network Node, and Methods therein for Access Control in a Communications Network

(71) Applicant: Telefonaktiebolaget LM Ericsson (publ), Stockholm (SE)

(72) Inventors: Andreas Höglund, Solna (SE); Ali Nader, Malmö (SE); Béla Rathonyi, Lomma (SE); Magnus Stattin, Upplands Väsby (SE)

(21) Appl. No.: 15/500,153

(22) PCT Filed: Dec. 1, 2016
(86) PCT No.: PCT/SE2016/051201

§ 371 Date: Jan. 30, 2017

Related U.S. Application Data
(60) Provisional application No. 62/268,565, filed on Dec. 17, 2015.

(51) Int. Cl. H04W 48/16; H04W 48/10; H04W 48/02

(52) U.S. Cl. CPC H04W 48/16; H04W 68/12; H04W 48/02; H04W 48/10

(57) ABSTRACT

A wireless device 108 and a method therein for access control in a communications network 100. The wireless device and a Radio Network Node (RNN) 106 operate in the communications network. The wireless device receives a Master Information Block (MIB) from the RNN. Further, the wireless device determines whether or not access barring is active by checking an access barring indication in the received MIB.

### TECHNICAL FIELD

Embodiments herein relate generally to a wireless device, a radio network node, and to methods therein. In particular they relate to access control in a communications network.

### BACKGROUND

Wireless devices such as terminals are also known as e.g. User Equipments (UEs), mobile terminals, stations (STAB), wireless terminals, communication devices and/or mobile stations. Terminals are enabled to communicate wirelessly in a communications network such as a wireless communications network or a cellular communications network, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the communications network.

Terminals may further be referred to as mobile telephones, cellular telephones, laptops, or tablets with wireless capability, just to mention some further examples. The terminals in the present context may be, for example, portable, pocket-storable, hand-held, computer-comprised, or vehicle-mounted or wall-mounted mobile devices, enabled to communicate voice and/or data, via the RAN, with another entity, such as another terminal or a server.

The communications network covers a geographical area which is divided into coverage areas, e.g. cell areas, wherein each coverage area being served by an access node such as a base station, e.g. a Radio Base Station (RBS), which sometimes may be referred to as e.g. “eNB”, “eNodeB”, “NodeB”, “B node”, or Base Transceiver Station (BTS), depending on the technology and terminology used. The base stations may be of different classes such as e.g. macro eNodeB, home eNodeB, micro eNodeB or pico base station, based on transmission power, functional capabilities and thereby also cell size. A coverage area, e.g. a cell, is the geographical area where radio coverage is provided by the base station at a base station site. One base station, situated on the base station site, may serve one or several coverage areas, e.g. cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

As for the Enhanced Access class Barring (EAB) in LTE, a reasonable outcome for Narrow Band IoT (NB-IoT) is that the wireless devices, e.g. the UEs, need to check the barring bitmap to see if access is allowed prior to trying to access. The bitmap will be broadcast in a separate System Information Block (SIB); herein referred to as “SIB14”, However, it should be understood that “SIB14” is just an example and that the separate SIB may have another suitable number. Further, this SIB is only transmitted when access control is activated. This is problematic for the wireless devices, e.g. the UEs, since they must attempt to decode something that is not necessarily there. For example, it would be difficult for the wireless device to differentiate between “SIB14” not being present and a bad radio channel. The wireless device may therefore be forced to perform several decoding attempts. Further, this is especially problematic for the wireless devices, e.g. the UEs, in Coverage Enhancement (CE) since these UEs must accumulate over a high number of time repetitions in order to try to detect and decode the signal. This will lead to unnecessary power consumption in the wireless devices, e.g. the UEs. Thus, it is a drawback for wireless devices providing Machine-Type Communications (MTC), since long battery life time is of high importance for MTC.

### SUMMARY

An object of embodiments herein is to address at least some of the above-mentioned drawbacks among others and to improve the performance in a wireless communications network.

According to one aspect of embodiments herein, the object is achieved by a method performed by a wireless device for access control in a communications network. The wireless device and a Radio Network Node (RNN) operate in the communications network.

The wireless device receives a Master Information Block (MIB) from the RNN.

Further, the wireless device determines whether or not access barring is active by checking an access barring indication in the received MIB.

According to another aspect of embodiments herein, the object is achieved by a wireless device for access control in a communications network. The wireless device and a Radio Network Node (RNN) are configured to operate in the communications network.

The wireless device is configured to receive a Master Information Block (MIB) from the RNN.

Further, the wireless device is configured to determine whether or not access barring is active by checking an access barring indication in the received MIB.

According to another aspect of embodiments herein, the object is achieved by a method performed by a Radio Network Node (RNN) for access control in a communications network. A wireless device and the RNN operate in the communications network.

When access to the RNN is to be allowed, the RNN sets an access barring indication in a Master Information Block (MIB) to indicate a cell access permission.

When access to the RNN is to be barred, the RNN sets the access barring indication in the transmitted MIB to indicate a cell access prohibition.

Further, the RNN transmits the MIB to the wireless device.

According to another aspect of embodiments herein, the object is achieved by a Radio Network Node (RNN) for access control in a communications network. A wireless device and the RNN are configured to operate in the communications network.

The RNN is configured to set an access barring indication in a Master Information Block (MIB) to indicate a cell access permission when access to the RNN is to be allowed.

The RNN is configured to set the access barring indication in the transmitted MIB to indicate a cell access prohibition when access to the RNN is to be barred.

Further, the RNN is configured to transmit the MIB to the wireless device.

According to another aspect of embodiments herein, the object is achieved by a computer program, comprising instructions which, when executed on at least one processor, causes the at least one processor to carry out the method performed by the wireless device.

According to another aspect of embodiments herein, the object is achieved by a computer program, comprising instructions which, when executed on at least one processor, causes the at least one processor to carry out the method performed by the RNN.

According to another aspect of embodiments herein, the object is achieved by a carrier comprising the computer program, wherein the carrier is one of an electronic signal, an optical signal, a radio signal or a computer readable storage medium.

Since the wireless device should defer from trying to access the RNN when the access barring indication in the received MIB indicates access barring and when the wireless device is determined to belong to a barred access class, the wireless device should not try to access the RNN when access is barred and thus only try to access the RNN when access is likely to be successful. Thereby, unnecessary power consumption on unsuccessful access attempts is avoided and interference in the communications network is reduced. This results in an improved performance in the wireless communications network.

An advantage of some embodiments herein is that the wireless device will not have to blindly decode a SIB, which is most often not present, in order to find out whether or not access barring is applied. This is advantageously since access barring is active only upon congestion, which is really rare. A main advantage of embodiments disclosed herein is therefore an improved battery life time to wireless devices, e.g. NB-IoT devices.

### BRIEF DESCRIPTION OF DRAWINGS

Examples of embodiments herein are described in more detail with reference to attached drawings in which:

FIG. 1 schematically illustrates embodiments of a communications network;

FIG. 2A is a flowchart schematically illustrating embodiments of a method in a wireless device;

FIG. 2B is a flowchart schematically illustrating embodiments of a method in a wireless device;

FIG. 3 is a flowchart schematically illustrating embodiments of a method in a wireless device;

FIG. 4 is schematically illustrates an exemplifying access barring bitmap comprised in a System Information Block (SIB), e.g. SIB14, and how the existence and nonexistence of such SIB may be indicated according to a Solution 1 and a solution 2, respectively; and

FIG. 5 is a block diagram schematically illustrating embodiments of a wireless device;

FIG. 6 is a flowchart schematically illustrating embodiments of a method in a radio network node;

FIG. 7 is a flowchart schematically illustrating embodiments of a method in a radio network node; and

FIG. 8 is a block diagram schematically illustrating embodiments of a radio network node.

### DETAILED DESCRIPTION

As part of developing embodiments herein, some problems with the state of the art communications networks will first be identified and discussed.

For the Internet of Things (IoT), e.g. Narrow Band IoT (NB-IoT), being standardized in LTE Release 13 (Rel-13) it has been agreed to provide a method for access control. The method is to be based on a bitmap, e.g. a barring bitmap, that will be transmitted in a separate System Information Block (SIB). As will be described below, the barring bitmap indicates one or more access classes that are barred from access. Thus, a wireless device belonging to a barred access class as indicated in the barring bitmap will not be allowed access to a Radio Network Node (RNN) transmitting the barring bitmap. The bitmap may be updated by using paging similar to the procedure for Enhanced Access Barring (EAB). For example, the change of EAB parameters may occur at any point in time. A Paging message is used to inform the wireless devices in a Radio Resource Control (RRC)_IDLE mode about a change of EAB parameters or that EAB SIB is no longer scheduled. If the wireless device receives a Paging message including the eab-ParamModification, it shall acquire relevant SIB according to schedulingInfoList contained in a separate SIB (SystemInformationBlockType1). The barring bitmap is sometimes herein referred to as an access barring bitmap. Further, it should be understood that the terms “bitmap”, “barring bitmap” and “access barring bitmap” are used interchangeably in this disclosure.

The access control mechanism will allow to differentiate between roaming categories, similar as in EAB, and between normal and exceptional reporting. The expression “normal reporting” is in this disclosure used for reporting things like temperature report, position, etc. whereas the expression “exceptional reporting” is used for alerts, e.g. emergency-alike alerts, such as temperature overload.

Further, an access control mechanism for the NB-IoT should be able to discriminate between different roaming wireless devices, e.g. UEs, e.g. the same roaming differentiation as for EAB. For example, in EAB, the communications network may choose to discriminate wireless devices classified according to one of the following categories, sometimes called eab-Category:
category a: corresponds to all wireless devices;
category b: corresponds to the wireless devices that are neither in their home-Public Land Mobile Network (PLMN) (HPLMN) nor in a PLMN that is equivalent to it; and
category c: corresponds to the wireless devices that are neither in the PLMN listed as most preferred PLMN of the country where the wireless devices are roaming in the operator-defined PLMN selector list on the Universal Subscriber Identity Module (USIM), nor in their HPLMN nor in a PLMN that is equivalent to their HPLMN.

Furthermore, the method needs some priority discrimination. One or more priority discrimination classes may be hard-coded, may be reported by normal reporting, or may be reported by high-priority and/or alarm and/or exception report. This may then need to be provided by a Non Access Stratum (NAS). The NAS is a functional layer in the Universal Mobile Telecommunications System (UMTS) and in the LTE wireless telecom protocol stacks between the core network and user equipment. This layer is used to manage the establishment of communication sessions and for maintaining continuous communications with the wireless device as it moves.

Yet further, in order to keep the procedures simple, it is assumed that the NB-IoT doesn't support Service Specific Access Control (SSAC) and Access Class Blocking (ACB) skip.

In some solutions, the barring bitmap is transmitted separately from other system information, and especially it is transmitted only when access control is enabled. The barring bitmap check is applicable to normal reports. A separate flag is broadcasted which indicates if exception reports are subject to barring bitmap check or not.

The other system information may be System Information Blocks (SIBS) used for broadcasting information related to cell configuration, conveying information about e.g. how to access the cell, what neighbouring cells there exist, and so on.

In order to overcome one or more drawbacks with the prior art, some embodiments herein relate to a method for providing an access barring indication to a wireless device, and especially to a method for providing an indication of an access barring in a main information block, such as a Master Information Block (MIB).

Thus, embodiments herein provide for transmission of an access barring indication to a wireless device, and especially for transmitting an indication of an access barring in a main information block, such as a Master Information Block (MIB).

Further, by embodiments herein, different methods of access barring indication are enclosed.

In some embodiments in this disclosure, the access barring indication comprised in the main information block, e.g. the MIB, is configured to indicate a presence of an access class barring SIB, e.g. the “SIB14” mentioned above. This would only require 1 bit in MIB and from this the wireless devices, e.g. the UE, may immediately see if Access Barring currently is applied in the cell served by a radio network node transmitting, e.g. broadcasting, the main information block.

In this disclosure the expressions “access class barring SIB”, “access barring SIB” and “SIB14” are used interchangeably.

It should be understood that wireless devices may be randomly divided into different classes, e.g. Access Class (AC) 0-9. The information about which classes the UE belongs to is stored on a Universal Subscriber Identity Module (USIM). Then, there exist some special classes AC 11-15 which get a special treatment, e.g. they may be used for operator testing. Further, AC 10 is used for emergency calls.

Some embodiments herein relate to a method performed by a wireless device for accessing a communications network.

The wireless device may receive a main information block, e.g. a MIB, from a radio network node operating in the communications network.

The wireless device may determine whether an access barring indication is comprised in the received main information block.

When an access barring indication is not comprised in the received main information block, the wireless device may access the communications network, e.g. the cell served by the radio network node transmitting the main information block.

Alternatively, when an access barring indication is comprised in the received main information block, the wireless device may determine whether or not it belongs to a barred access class of wireless devices.

When the wireless device does not belong to the barred access class of wireless devices, the wireless device may access the communications network, e.g. the cell served by the radio network node transmitting the main information block.

Alternatively, when the wireless device does belong to the barred access class of wireless devices, the wireless device may not access the communications network, e.g. the cell served by the radio network node transmitting the main information block. In some embodiments, the wireless device should defer from trying to access the communications network for a certain period of time, e.g. a predefined period of time. This period of time is sometimes herein referred to as a back-off time.

Further, some embodiments herein relate to a method performed by a Radio Network Node (RNN) for access control in a communications network. The RNN may determine cell congestion, i.e. it determines whether or not one or more of its serving cells are experiencing congestion.

When one or more of its cells are not congested, the RNN may stop broadcasting the barring bitmap in SIB and may set barring bitmap indication in MIB to indicate cell access permission, e.g. the barring bitmap indication may be set to 0. It should be understood that the RNN may also stop broadcasting the SIB, and not only stop broadcasting the barring bitmap in the SIB.

Alternatively, when one or more of its cells are congested, the RNN may start broadcasting the barring bitmap in SIB and may set barring bitmap indication in MIB to indicate cell access prohibition, e.g. the barring bitmap indication may be set to 1.

Furthermore, some embodiments herein relate to a wireless device and a Radio Network Node (RNN) comprising means configured to perform one or more actions described herein.

Embodiments herein comprise one or more other modules configured to realise features and to perform actions described herein.

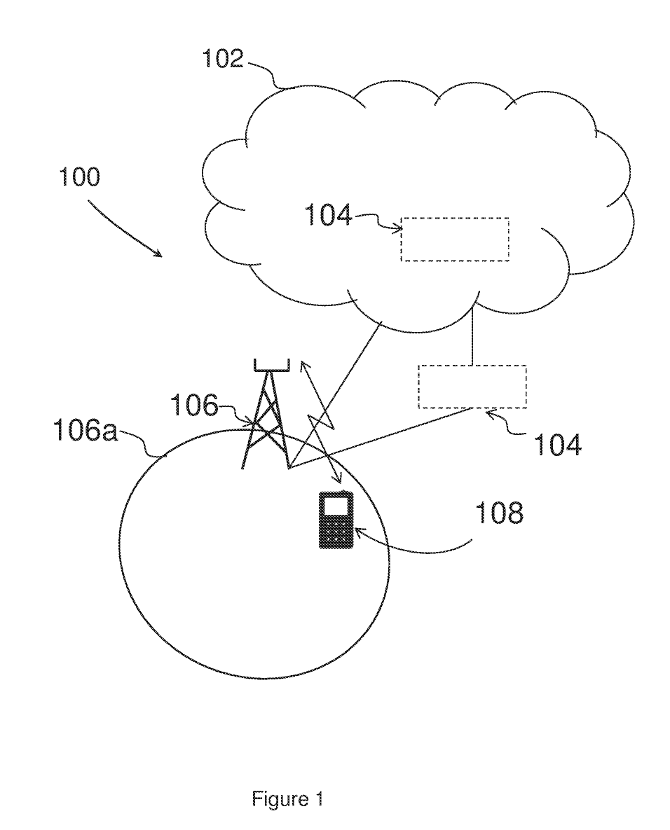

As schematically illustrated in FIG. 1, embodiments herein relate to a communications network 100. The communications network 100 may be a wireless communications network such as an Universal Mobile Telecommunications System (UMTS) network, an LTE network, a WCDMA network, an GSM network, any 3GPP cellular network, Wimax, or any other wireless communication network or system.

A core network 102 is comprised in the communications network 102. The core network 102 may be an UMTS core network, a LTE core network, a WCDMA core network, an GSM core network, any 3GPP cellular core network, a Wimax core network, or a core network of any other wireless communication network or system.

A network node 104 may be comprised in or arranged in communication with the core network 102. The network node 104 may be a Radio Network Controller (RNC) operating in an UMTS network. In some embodiments, the network node 104 is a Base Station Controller (BSC), a Mobile Switching Center (MSC), a media Gateway (MGw), a Serving GPRS Support Node (SGSN) or a Mobility Management Entity (MME). Further, in some embodiments, the network node 104 is a base station.

A Radio Network Node (RNN) 106 is arranged and configured to operate in the communication network 100. The RNN 106 is configured for wireless communication with wireless devices, such as a wireless device 108, when they are located within a coverage area 106a, e.g. a geographical area 106a served by the RNN 106. It should be understood that the RNN 106 may serve or manage a plurality of coverage areas 106a, even though only one is illustrated in FIG. 1 for clarity reasons. The one more coverage areas 106 are sometimes in this disclosure referred to as one or more cells 106a.

The RNN 106 may be a transmission point such as a radio base station, for example an eNB, an eNodeB, or an Home Node B, an Home eNode B or any other network node capable to serve a user equipment or a machine type communication device in a communications network, such as the communications network 100. The RNN may further be configured to communicate with the network node 104.

The wireless device 108, herein also referred to as a user equipment or UE, operates in the communications network 100. The wireless device 108 may e.g. be a user equipment, a mobile terminal or a wireless terminal, a mobile phone, a computer such as e.g. a laptop, a Personal Digital Assistant (PDA) or a tablet computer, sometimes referred to as a surf plate, with wireless capability, or any other radio network units capable to communicate over a radio link in the communications network 100. Please note the term user equipment used in this document also covers other wireless devices such as Machine-Type Communications (MTC) devices, or Machine to Machine (M2M) devices, even though they do not have any user.

In this section, the embodiments herein will be illustrated in more detail by a number of exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

The embodiments herein are exemplified to the case of the LTE technology. However, such embodiments may be applied to any other technology where for example the access control needs to be improved.

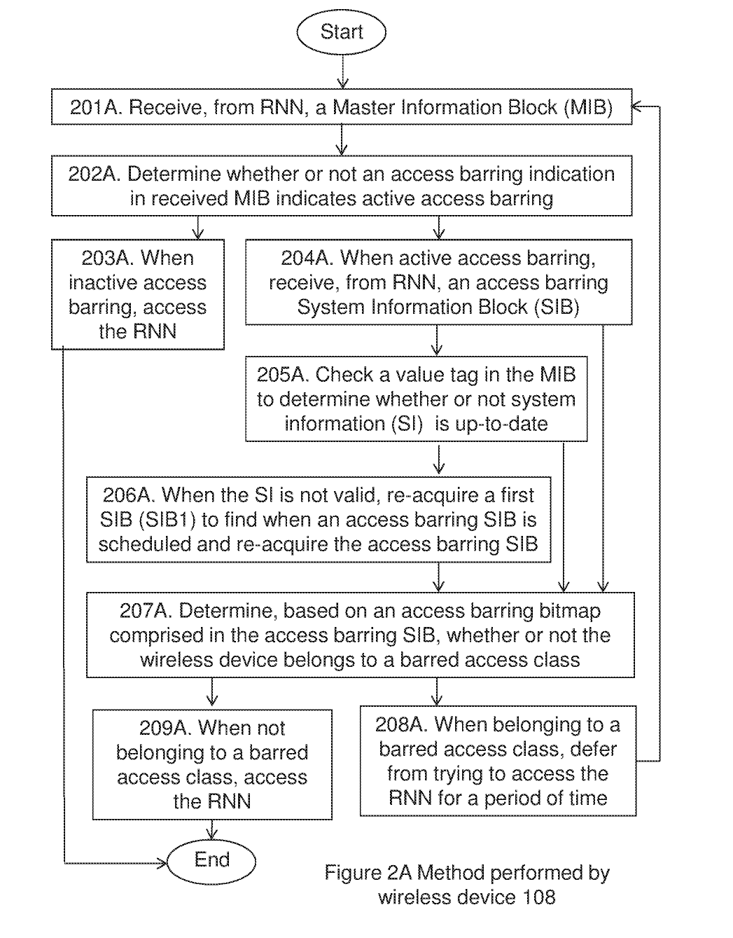

FIG. 2A schematically illustrates embodiments of a method performed by the wireless device 108 for access control in the communications network 100. As previously mentioned, the wireless device 108 and the RNN 106 operate in the communications network 100.

One or more of the Actions below may be combined and/or performed in another suitable order. Further, one or more actions may be optional.

Action 201A

The wireless device 108 receives a MIB from the RNN 106.

This Action relates e.g. to Actions 201B and 1) which will be described in more detail below.

Action 202A

The wireless device 108 determines whether or not an access barring is active by checking an access barring indication in the received MIB. Thus, by checking the access barring indication, the wireless device 108 determines whether or not the access barring indication in the received MIB indicates an active access barring.

The access barring indication may be an explicit indication indicating the active access barring, and the explicit indication may be a bit or a flag. Alternatively and in some embodiments, the access barring indication is an implicit indication indicating an active access barring, and the implicit indication may be a configuration identity.

This Action relates e.g. to Actions 202B-203B, 2) and 3) which will be described in more detail below.

Action 203A

The wireless device 108 accesses the RNN 106 when access barring is inactive.

This Action relates e.g. to Actions 203B and 2) which will be described in more detail below.

Action 204A

In some embodiments and when access barring is active, the wireless device 108 receives an access barring SIB from the RNN 106.

This Action relates e.g. to Actions 204B, 304 and 3) which will be described in more detail below.

Action 205A

In some embodiments and when access barring is active, the wireless device 108 checks a value tag in the MIB to determine whether or not the wireless device 108 has up-to-date system information. The system information may relate to the scheduling of an access barring SIB.

This Action relates to e.g. Action 3)a. which will be described in more detail below.

Action 206A

When the system information is not valid, the wireless device 108 re-acquires a first SIB SIB1 to find when the access barring SIB is scheduled and re-acquires the access barring SIB.

This Action relates to e.g. Action 3)a ii, that will be described in more detail below.

Action 207A

The wireless device 108 may determine, based on an access barring bitmap comprised in the access barring SIB, whether or not the wireless device 108 belongs to a barred access class of wireless devices.

This Action relates e.g. to Actions 204B, 304 and 3)b. which will be described in more detail below.

Action 208A

The wireless device 108 may defer from trying to access the RNN 106 for a period of time when the wireless device belongs to a barred access class of wireless devices.

In some embodiments, the period of time is dependent on a modification period of time that is specific for an access barring SIB. Further, the access barring bitmap comprised in the access barring SIB may be kept unchanged during the modification period of time.

This Action relates e.g. to Actions 206B, 306 and 3)b ii. which Actions will be described in more detail below.

Action 209A

In some embodiments and when access barring is active, the wireless device 108 access then RNN 106 when the wireless device 108 does not belong to a barred access class.

This Action relates e.g. to Actions 205B, 303, 304 and 3)b i, which Actions will be described below.

FIG. 2B schematically illustrates embodiments of a method performed by the wireless device 108 for accessing the communications network 100. This may also be referred to as embodiments of a method performed by the wireless device 108 for access control in the communications network 100. As previously mentioned, the wireless device 108 and the RNN 106 operate in the communications network 100.

One or more of the Actions below may be combined and/or performed in another suitable order. Further, one or more actions may be optional. Furthermore, one or more of Actions 201B-206B to be described below relate to one or more of Actions 201A-209A previously described.

In Action 201B, the wireless device 108 receives a main information block, e.g. a MIB, from the radio network node 106 operating in the communications network 100.

In Action 202B, the wireless device 108 determines whether or not an access barring indication is comprised in the received main information block, e.g. the received MIB. The access barring indication indicates a cell access prohibition by indicating a presence of an access barring System Information Block (SIB). The indication may be an implicit indication such as a configuration identity (id) or an explicit indication such as a specific bit or flag indicating that there is an active access barring.

Thus, in other words and according to some embodiments, the access barring indication is a flag, which flag is always comprised in the Master Information Block and which flag indicates whether access barring is enabled or not.

In Action 203B, when an access barring indication is not comprised in the received main information block, access barring is not activated, and therefore the wireless device 108 is free to access the communications network 100, e.g. the cell served by the radio network node 106 transmitting the main information block.

In other words and for some embodiments, particularly when the access barring indication is an implicit indication, the wireless device 108 accesses the RNN 106 when the access barring indication is absent in the received MIB. For other embodiments, particularly when the access barring indication is a specific bit or flag, the access barring indication is still comprised in the MIB, but when it indicates that access barring is not enabled, the wireless device 108 may access the RNN 106. Thus, in such embodiments, the wireless device 108 determines whether or not access barring is activated by checking the access barring indication.

In Action 204B, when an access barring indication is comprised in the received main information block, access barring is activated, and therefore the wireless device 108 determines whether or not it belongs to a barred access class of wireless devices. By the expression “barred access class” when used in this disclosure is meant an access class that is not allowed to access the communications network, e.g. the cell. For example, the barred access class may be one or more of the access classes (AC) 0-15.

In other words, when the access barring indication is comprised in the received MIB and indicates that access barring is enabled, the wireless device 108 determines whether or not the wireless device 108 belongs to a barred access class of wireless devices.

In Action 205B, when the wireless device 108 does not belong to the barred access class of wireless devices, the wireless device 108 is free to access the communications network 100, e.g. the cell served by the radio network node 106 transmitting the main information block.

In Action 206B, when the wireless device 108 does belong to the barred access class of wireless devices, the wireless device 108 may not access the communications network 100, e.g. the cell served by the radio network node 106 transmitting the main information block. In some embodiments, the wireless device 108 should defer from trying to access the communications network 100 for a certain period of time, e.g. a predefined period of time. This period of time is sometimes herein referred to as a back-off time.

As will be described below, the period of time may be dependent on a modification period time that is specific for the access barring SIB. In such embodiments, an access barring bitmap comprised in the access barring SIB may be kept unchanged during the modification period of time.

As will be described below in e.g. relation to the Actions 3), 3) a, 3) ai and 3) aii, the wireless device 108 may check a value tag valueTag in the MIB to determine whether or not scheduling of the access barring SIB within a first SIB, SIB1, is valid; and when scheduling of the access barring SIB within the first SIB, SIB1, is not valid, the wireless device 108 may re-acquire the first SIB, SIB1, to find when the access barring SIB is scheduled.

As will also be described below, the wireless device 108 may acquire an access barring bitmap comprised in the access barring SIB, which access barring SIB is broadcasted from the RNN 106. In such embodiments, the wireless device 108 determines whether or not the wireless device 108 belongs to a barred access class of wireless devices by determining whether or not the wireless device 108 belongs to the barred access class based on the acquired access barring bitmap.

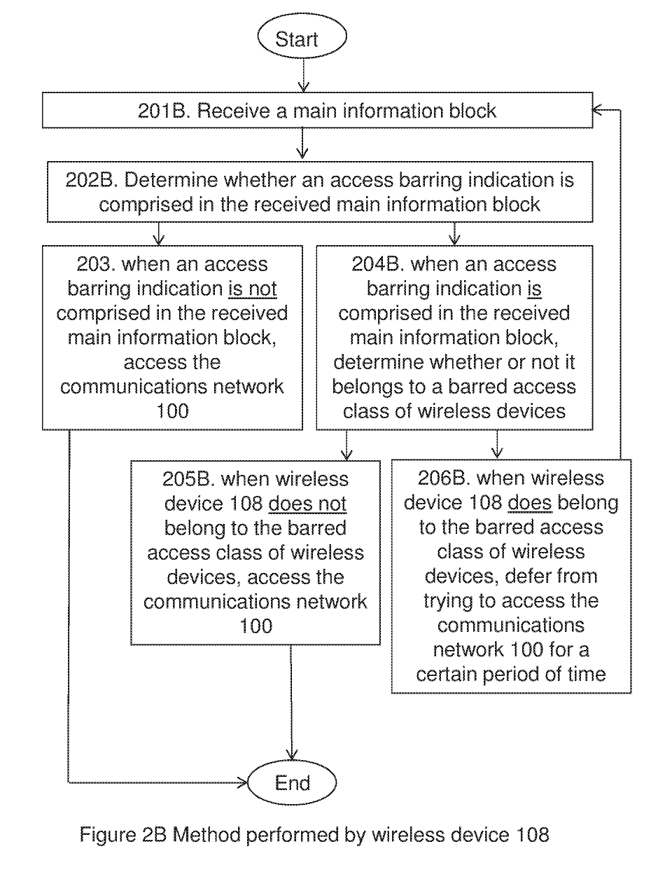

The Actions 201A-208A, and 201B-206B described above with reference to FIGS. 2A and 2B relate to the Actions 301-305 of FIG. 3, which figure schematically illustrates exemplifying embodiments of a method performed by the wireless device 108.

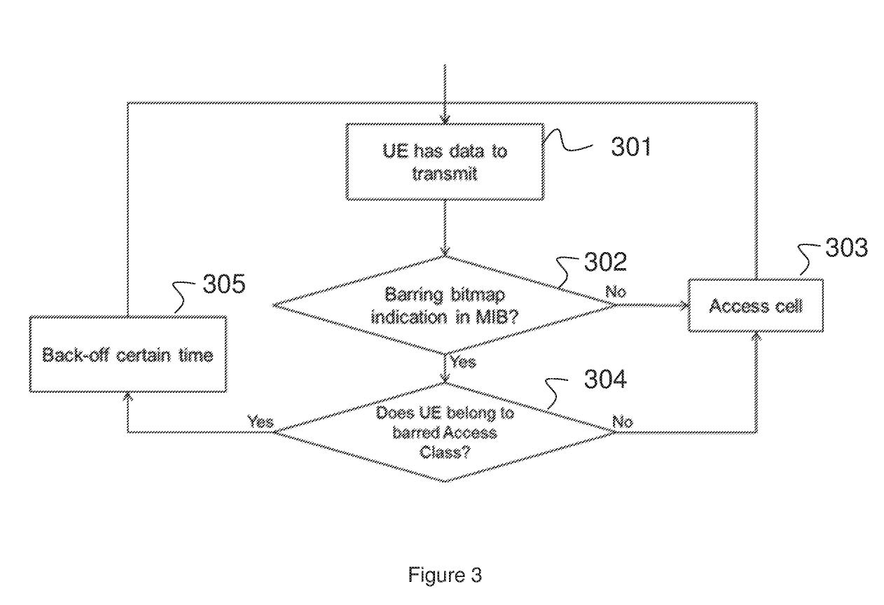

A wireless device 108 which has data to transmit, cf. Action 301, checks the access barring indication to see if it is allowed to access the communications network 100. With embodiments disclosed herein, the wireless device 108 will check the access barring indication, e.g. a “SIB14” presence indication’ bit, in the MIB, cf. Action 302. Thus, the access barring indication may indicate whether or not the access barring SIB, e.g. the “SIB14”, is present. If this bit is set to ‘0’ this means that the access barring is not activated in the cell, e.g. the cell 106a, and that the access barring SIB, “SIB14”, is not present. The wireless device 108 is then free the access the cell, cf. Action 303, and need not check the access barring bitmap in “SIB14”. This is schematically illustrated as “Solution 1” in FIG. 4, which figure schematically illustrates an exemplifying access barring bitmap comprised in a System Information Block (SIB), e.g. SIB14, and how the existence and nonexistence of such SIB may be indicated according to a Solution 1 and a solution 2, respectively. The arrows between the rows of the bitmap indicate a change in the bitmap, e.g. each arrow means that SIB14 is updated to bar another class.

If the indication bit, e.g. the access barring indicating bit, in the MIB is set to ‘1’ this means that the access barring is activated in the cell and the access barring SIB, e.g. the “SIB14”, is scheduled by SIB1 and is being broadcasted in the cell. The wireless device 108 should then, prior to accessing the communications network 100, acquire the access barring SIB, e.g. the “SIB14”, and check if access is allowed, cf. Action 304. The wireless device 108 may either check the scheduling information for “SIB14” in SIB1, or rely on that the scheduling has not changed and attempt to decode the “SIB14” in the previous location.

Updating most SIBs may give rise to an update of the valueTag in SIB1 and to the broadcast of systemInfoModification in the paging message in order to notify all wireless device in the cell of the SI update. However, in embodiments disclosed herein, updates of EAB barring in the access barring SIB, e.g. the SIB14, does not give rise to this, since embodiments herein relate to communications networks for NB-IoT which communications networks have limited amount of DL resources available and thus transmit a reduced amount of system information change notifications. Further, change notifications are used to indicate changes after upcoming modification periods, whereas the barring updates according to embodiments herein are meant to apply at a much faster rate. Furthermore, in some embodiments disclosed herein, notification is used e.g. in case the scheduling of the access barring SIB SIB14, e.g. how often and when it is broadcast, changes as compared to the scheduling information the wireless device 108 already have. As a result, the wireless device 108 would read SIB1 and find the SIB14 scheduling information. If that information is not changed, then no notification would be needed.

In some embodiments, the activation of access barring, which means the inclusion or removal of the periodical broadcast of the new access barring SIB, e.g. “SIB14”, may give rise to a change in a valueTag and in an SI update notification in paging. This is schematically illustrated as “Solution 2” in FIG. 4. From this the wireless device 108 may always be aware of whether the access barring SIB, e.g. the “SIB14”, is being broadcasted or not. Initially the wireless device 108 checks what SIBs are scheduled in SIB1, and it will be notified by the addition and/or removal of the access barring SIB, e.g. the “SIB14”, through paging. In case the wireless device 108 is out-of-coverage it will check the valueTag in SIB1 when it returns to be in coverage. Thereby, the wireless device ensures it has an up-to-date SI.

Using any of the mentioned solutions, e.g. any of the “Solution 1” and the “Solution 2” or parts thereof, will assure that the wireless device 108 has correct information on whether or not the access barring SIB, e.g. “SIB14”, is being broadcasted. Thereby, the wireless device 108 will never attempt to decode it unnecessarily.

If the wireless device 108 finds the cell, e.g. the cell 106a, it would like to access barred, the wireless device 108 should back off for some period of time before attempting to access the cell again, cf. Action 305 of FIG. 3. This period of time may be dependent on a new modification period, e.g. a new modification period of time, specific for the access barring SIB, e.g. the “SIB14” or according to some embodiments it may be device vendor specific. Especially for Coverage Enhancements (CE), in which case several time repetitions must be accumulated in order to correctly decode the signal, it becomes unclear what “ensuring that access is allowed by checking the barring bitmap” means since decoding of “SIB14” may take more than 100 ms. In this case a specific modification period of time for “SIB14” may be needed to avoid ambiguities. During this modification period of time, the RNN 106, e.g. the eNB, ensures that the barring bitmap is not updated and if the wireless device 108 has acquired the barring bitmap during this period and it indicates that the wireless device 108 is not barred, the wireless device 108 is allowed to access the cell throughout the current modification period, e.g. the modification period of time.

When the wireless device 108 re-attempts to access the communications network 100 after this modification period of time it may perform one or more of the actions below:

1) Acquire the MIB to check the flag, e.g. the access barring indication comprised in the MIB, which indicates the presence of the access barring SIB, e.g. the “SIB14”, and whether or not access barring is active. This relates to e.g. Actions 201A-202A, and 201B-202B previously described.

2) If the bit is ‘0’, e.g. if the access barring indication comprised in the MIB is a bit that is ‘0’, access is allowed and the wireless device 108 will not consider any barring or read “SIB14”. This relates to e.g. Actions 203A, and 203B previously described.

3) If the bit is ‘1’, e.g. if the access barring indication comprised in the MIB is a bit that is ‘1’, the wireless device 108 will consider the cell as barred and,

a. Check the valueTag in MIB.

If the wireless device 108 has up-to-date system information according to the valueTag the wireless device 108 will know that scheduling of the access barring SIB, e.g. “SIB14” is unchanged and start to decode it. By decoding the access barring SIB, the wireless device 108 will acquire the access barring bitmap.

ii. If the system info is not valid, the wireless device 108 will re-acquire SIB1 to find when the access barring SIB, e.g. the “SIB14”, is scheduled. Thereafter, the wireless device 108 will start to decode the access barring SIB, e.g. the “SIB14”, As previously mentioned, by decoding the access barring SIB, the wireless device 108 will aquire the access barring bitmap.

b. See if it, e.g. the wireless device 108, is barred according to the barring bitmap, e.g. the access barring bitmap, in the access barring SIB, e.g. in the “SIB14”.

If the wireless device 108 is not barred, the wireless device 108 will access the cell.

ii. If the wireless device 108 is barred, the wireless device 108 will back off for some time or re-attempt after the subsequent “SIB14”-modification period.

Action 3) described above relates to e.g. Actions 204A-209A, 204B-206B and 304 previously described.

Potentially (for the wireless device 108), the wireless device 108 may opportunistically already in beginning of action 3) above, or even in parallel with action 1) above, start to decode the access barring SIB, e.g. “SIB14”, based on the old scheduling. If the valueTag has been updated etc. it will simply flush this decoding attempt and start over.

As previously described the access barring indication may be a flag. Further, the flag may be set to true to indicate access barring and to false to indicate access permission.

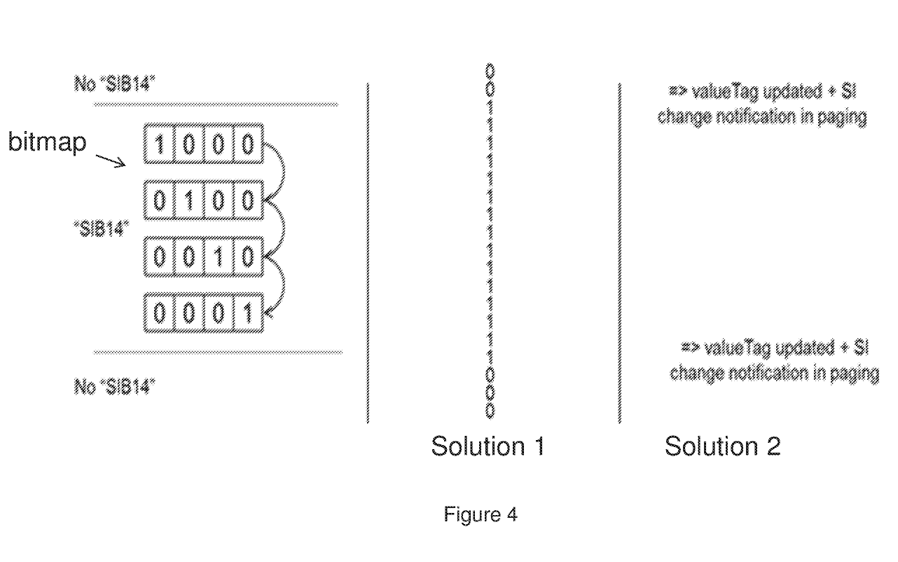

As schematically illustrated in FIG. 5, the embodiments herein may be implemented through one or more processors, such as a processor 506 in the wireless device 108, together with computer program code for performing the functions and actions of the embodiments herein. The program code may be implemented in one or several network nodes in the communications network and/or in the wireless device. The program code mentioned above may also be provided as a computer program product, for instance in the form of a data carrier carrying computer program code for performing the embodiments herein when being loaded into network node or communication device. One such carrier may be in the form of a CD ROM disc. It is however feasible with other data carriers such as a memory stick. The computer program code may furthermore be provided as pure program code on a server and downloaded to the wireless device.

The wireless device 108 may further comprise a memory 505 comprising one or more memory units. The memory is arranged to be used to store obtained information, store data, configurations, schedulings, and applications etc, to perform the methods herein when being executed in the communications network or the wireless device.

The wireless device 108 may further comprise means 500, 501, 502, 503, 504 configured to transmit transmissions, e.g. signals, receive transmissions, to determine indications, to access the communications network etc. Such means may be realised by an input/output interface 500, a receiving module 501, a transmitting module 502, a determining module 503, an accessing module 504, etc. adapted to transmit, receive, determine, access etc. as described herein.

Those skilled in the art will also appreciate that embodiments herein comprises one or more modules to realize features and functions and to perform actions described herein. The modules may refer to a combination of analog and digital circuits, and/or one or more processors configured with software and/or firmware, e.g. stored in the memory, that when executed by the one or more processors such as the processor in the wireless device perform as described herein. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

Thus, embodiments herein relate to a wireless device 108 for access control in a communications network 100. As previously mentioned, the wireless device 108 and the RNN 106 are configured to operate in the communications network 100.

In some embodiments, the wireless device 108 comprises the input and output interface 500 configured to communicate with one or more RNNs, e.g. the RNN 106. The input and output interface 500 may comprise a wireless receiver (not shown) and a wireless transmitter (not shown).

The wireless device 108 is configured to receive, by means of the receiving module 501 configured to receive, a transmission, e.g. a signal, from one or more RNNs, e.g. the RNN 106. The receiving module 501 may be implemented by or arranged in communication with the processor 506 of the wireless device 108.

The wireless device 108 is configured to receive, from the RNN 106, the MIB.

An access barring indication indicating access barring may be comprised in the received MIB. In some embodiments, the access barring indication indicates a cell access prohibition by indicating a presence of an access barring SIB. As previously mentioned the access barring indication may be a flag in the MIB. Thus, the flag in the MIB may indicate the cell access prohibition. As also previously mentioned, the access barring SIB is sometimes in this disclosure referred to as SIB14.

The access barring indication may be one out of an implicit indication indicating an active access barring or an explicit indication indicating the active access barring. The implicit indication may be a configuration identity and the explicit indication may be a bit or a flag.

Further, the wireless device 108 may be configured to receive an access barring SIB from the RNN 106. For example, this may be the case when access barring is active. Based on the received access barring SIB the wireless device 108 may determine whether or not it belongs to a barred access class of wireless devices.

The wireless device 108 is configured to transmit, by means of the transmitting module 502 configured to transmit, a transmission, e.g. a signal, to one or more RNNs, e.g. the RNN 106. The transmitting module 502 may be implemented by or arranged in communication with the processor 506 of the wireless device 108.

The wireless device 108 is configured to determine, by means of the determining module 503 configured to determine, whether or not access barring is active. The determining module 503 may be implemented by or arranged in communication with the processor 506 of the wireless device 108.

The wireless device 108 may be configured to determine whether or not access barring is active by checking an access barring indication in the received MIB.

Further, the wireless device 108 may be configured to determine whether or not access barring indication is comprised in the received MIB.

In some embodiments, the wireless device 108 is configured to determine whether or not the wireless device 108 belongs to a barred access class of wireless devices.

In order to determine whether or not the wireless device 108 has up-to-date system information, the wireless device 108 may be configured to check a value tag in the MIB. Thus, the wireless device 108 may be configured to determine whether or not scheduling of the access barring SIB within a first SIB, SIB1, is valid by checking a value tag in the MIB. Further, the wireless device 108 may be configured to re-acquire the first SIB, SIB1, to find out when the access barring SIB is scheduled, when the system information is not valid such as when the scheduling of the access barring SIB within the first SIB, SIB1, is not valid.

In some embodiments, the wireless device 108 is configured to determine whether or not the wireless device 108 belongs to a barred access class based on an acquired access barring bitmap. The access barring bitmap may be comprised in the access barring SIB received from the RNN 106 as described above.

The wireless device 108 is configured to access, by means of the accessing module 504 configured to access, the communications network 100, e.g. the RNN 106. The accessing module 504 may be implemented by or arranged in communication with the processor 506 of the wireless device 108.

The wireless device 108 may be configured to not access, i.e. to defer from trying to access, the RNN 106 for a period of time when an access barring indication comprised in the received MIB indicates access barring and when the wireless device 108 is determined to belong to a barred access class of wireless devices.

The period of time may be dependent on a modification period time that is specific for the access barring SIB. In such embodiments, the access barring bitmap comprised in the access barring SIB is kept unchanged during the modification period of time.

In some embodiments, the wireless device 108 is configured to access the RNN 106 when the access barring indication is absent in the received MIB.

In other words and for some embodiments, particularly when the access barring indication is an implicit indication, the wireless device 108 is configured to access the RNN 106 when the access barring indication is absent in the received MIB. For other embodiments, particularly when the access barring indication is a specific bit or flag, the access barring indication is still comprised in the MIB, but when it indicates that access barring is not enabled, the wireless device 108 may be configured to access the RNN 106. Thus, in such embodiments, the wireless device 108 is configured to determine whether or not access barring is activated by checking the access barring indication.

In some embodiments, the wireless device 108 is configured to access the RNN 106 when the access barring indication is comprised in the received MIB and when the wireless device 108 does not belong to the barred access class.

The wireless device 108 is configured to acquire, by means of an acquiring module 507 configured to acquire, information such as a MIB, a SIB or parts thereof. The acquiring module 507 may be implemented by or arranged in communication with the processor 506 of the wireless device 108.

In some embodiments, the wireless device 108 is configured to acquire an access barring bitmap comprised in the access barring SIB. The access barring SIB may be broadcasted from the RNN 106.

It should also be understood that the wireless device 108 may be configured to re-acquire information, such as re-acquire a MIB, a SIB or an access barring bitmap.

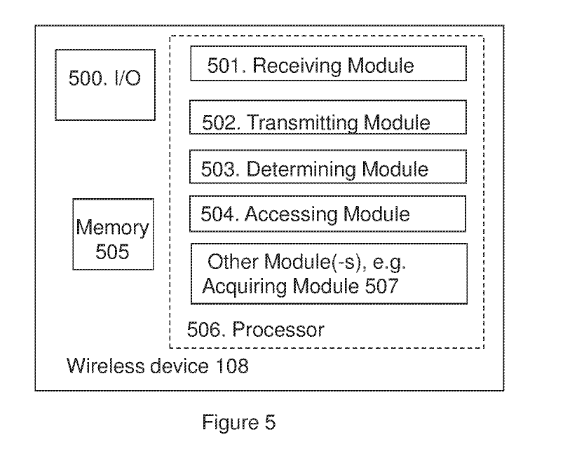

FIG. 6 schematically illustrates embodiments of a method performed by the RNN 106 for access control in the communications network 100. As previously mentioned, the RNN 106 and the wireless device 108 operate in the communications network 100. One or more of the Actions below may be combined and/or performed in another suitable order. Further, one or more actions may be optional.

In Action 601, the RNN 106 determines cell congestion, i.e. it determines whether or not one or more of its serving cells, e.g. the cell 106a, are experiencing congestion.

When one or more of its cells are not congested, in Action 602, the RNN 106 stops broadcasting barring bitmap in the SIB and sets a barring bitmap indication in the MIB to indicate a cell access permission, e.g. the barring bitmap indication may be set to 0.

As previously mentioned, the barring bitmap indication is sometimes herein referred to as an access barring indication and the barring bitmap is sometimes in herein referred to as an access barring bitmap.

Thus, in other words, when access to the RNN 106 is to be allowed, the RNN 106 sets an access barring indication in the MIB to indicate the cell access permission.

Further, when access to the RNN 106 is to be allowed, the RNN 106 may stop broadcasting the access barring bitmap.

As previously mentioned, the access barring indication may be one out of an implicit indication indicating an active access barring and an explicit indication indicating the active access barring. The implicit indication may be a configuration identity and the explicit indication may be a bit or a flag.

Further, the SIB is sometimes in this disclosure referred to as an access barring SIB. As will be described in more detail below, the RNN 106 may set a value tag in the MIB to indicate a scheduling of the access barring SIB within a first SIB SIB1.

When one or more of its cells are congested, in Action 603, the RNN 106 starts broadcasting the barring bitmap in the SIB and sets the barring bitmap indication in the MIB to indicate a cell access prohibition, e.g. the barring bitmap indication may be set to 1. In other words, when access to the RNN 106 is to be barred, the RNN 106 sets the access barring indication in the transmitted MIB to indicate the cell access prohibition. Further, when access to the RNN 106 is to be barred, the RNN 106 may start broadcasting the access barring bitmap. As will be described below and in some embodiments, the RNN 106 keeps the access barring bitmap unchanged during a modification period of time, which modification period time is specific for the access barring SIB.

In Action 604, the RNN 106 transmits the MIB to the wireless device 108.

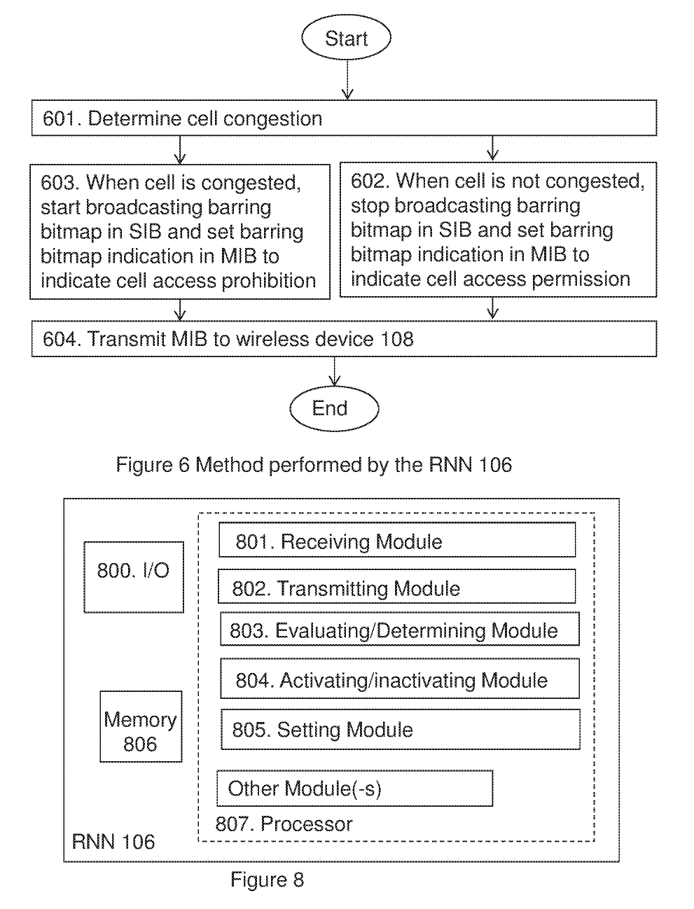

The Actions 601-604 described above relate to Actions 701-709 of FIG. 7. FIG. 7 schematically illustrates embodiments of a method performed by the RNN 106 for access control in the communications network 100. As previously mentioned, the RNN 106 and the wireless device 108 operate in the communications network 100. One or more of the Actions below may be combined and/or performed in another suitable order. Further, one or more actions may be optional.

In Action 701, the RNN 106 evaluates the cell congestion in the communications network 100. That is, the RNN 106 evaluates whether or not its serving cell(-s), e.g. the cell 106a, is experiencing a congestion.

In Action 702 the RNN 106 checks if its serving cell(-s) is congested.

If one or more of its cells are not congested, the RNN 106 performs one or more of the Actions 703-705 otherwise it performs one or more of Actions 706-708, which Actions will be described below.

Thus, when the one or more cells are not congested, the RNN 107 inactivates in Action 703 access barring, in Action 704 the RNN 106 stops broadcasting the barring bitmap in the SIB, and in Action 705 the RNN 106 sets the barring bitmap indication in the MIB to 0. As previously mentioned, the barring bitmap indication is sometimes herein referred to as the access barring indication, and the SIB is sometimes in this disclosure referred to as the access barring SIB.

When one or more of the cells are congested, the RNN 106 activates in Action 706 the access barring, in Action 707 the RNN 106 starts to broadcast the barring bitmap in the SIB, and in Action 708 the RNN 106 sets the barring bitmap indication in MIB to 1.

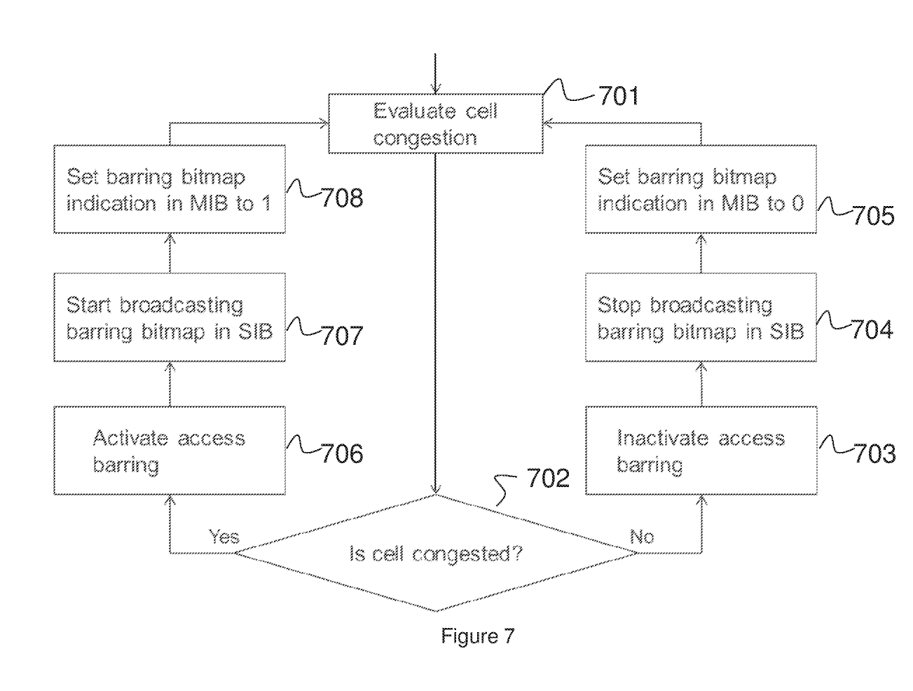

As schematically illustrated in FIG. 8, the embodiments herein may be implemented through one or more processors, such as a processor 807 in the RNN 106, together with computer program code for performing the functions and actions of the embodiments herein. The program code may be implemented in one or several network nodes both in the cellular network and/or in a non-cellular network and/or in the RNN 106. The program code mentioned above may also be provided as a computer program product, for instance in the form of a data carrier carrying computer program code for performing the embodiments herein when being loaded into the RNN 106. One such carrier may be in the form of a CD ROM disc. It is however feasible with other data carriers such as a memory stick. The computer program code may furthermore be provided as pure program code on a server and downloaded to the RNN 106.

The RNN 106 may further comprise a memory 806 comprising one or more memory units. The memory is arranged to be used to store obtained information, store data, configurations, schedulings, and applications etc. to perform the methods herein when being executed in the RNN 106.

The RNN 106 may further comprise means and/or modules 800, 801, 802, 803, 804 configured to transmit signals, receive signals, to determine congestions, indications, bitmaps, etc., to decide about activation and inactivation of access control, e.g. access barring, and to set indications, etc. Such means may be realised by an input/output interface 800, a receiving module 801, a transmitting module 802, an evaluating/determining module 803, an activating and inactivating module 804, and an setting module 805 etc. adapted to transmit, e.g. broadcast, receive, evaluate, determine, activate, inactivate, set indications etc. as described herein.

Those skilled in the art will also appreciate that embodiments herein comprises one or more modules to realize features and functions and to perform actions described herein. The modules may refer to a combination of analog and digital circuits, and/or one or more processors configured with software and/or firmware, e.g. stored in the memory, that when executed by the one or more processors such as the processor in the RNN perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

Thus, embodiments herein relate to a RNN 106 for access control in a communications network 100. As previously mentioned, the wireless device 108 and the RNN 106 are configured to operate in the communications network 100.

In some embodiments, the RNN 106 comprises the input and output interface 800 configured to communicate with one or more wireless devices, e.g. the wireless device 108. The input and output interface 800 may comprise a wireless receiver (not shown) and a wireless transmitter (not shown).

The RNN 106 is configured to receive, by means of the receiving module 801 configured to receive, a transmission, e.g. a signal, from one or more wireless devices, e.g. the wireless device 108. The receiving module 801 may be implemented by or arranged in communication with the processor 807 of the RNN 106.

The RNN 106 is configured to transmit, by means of the transmitting module 802 configured to transmit, a transmission, e.g. a signal, to one or more wireless devices, e.g. the wireless device 108. The transmitting module 802 may be implemented by or arranged in communication with the processor 807 of the RNN 106.

The RNN 106 is configured to transmit a MIB to the wireless device 108.

In some embodiments, the RNN 106 is configured to stop broadcasting an access barring bitmap in access barring SIB when access to the RNN 106 is to be allowed. Further, the RNN 106 may be configured to start broadcasting an access barring bitmap in access barring SIB when access to the RNN 106 is to be barred.

The RNN 106 may be configured to evaluate or determine, by means of the evaluating/determining module 803 configured to evaluate and/or determine, cell congestion, i.e. determining whether or not one or more of its serving cells are experiencing congestion. The determining module 803 may be implemented by or arranged in communication with the processor 807 of the RNN 106.

The RNN 106 is configured to activate or inactivate, by means of the activating/inactivating module 804 configured to activate or inactivate, access barring. The activating/inactivating module 804 may be implemented by or arranged in communication with the processor 807 of the RNN 106.

The RNN 106 is configured to set, by means of the setting module 805 configured to set, an access barring indication in a MIB. The setting module 805 may be implemented by or arranged in communication with the processor 807 of the RNN 106.

The RNN 106 may be configured to set the access barring indication in the MIB to indicate a cell access permission when access to the RNN 106 is to be allowed.

Further, the RNN 106 may be configured to set the access barring indication in the MIB to indicate a cell access prohibition when access to the RNN 106 is to be barred.

As previously mentioned, the access barring indication may be an implicit indication indicating an active access barring or an explicit indication indicating the active access barring. The implicit indication may be a configuration identity and the explicit indication may be a bit or a flag.

In some embodiments, the RNN 106 is configured to set a value tag in the MIB to indicate a scheduling of the access barring SIB within a first SIB SIB1.

The RNN 106 may be configured to set the access barring bitmap. As previously mentioned the access barring bitmap indicates that one or more wireless devices belonging to one or more access classes are barred from access. The RNN 106 may be configured to keep the access barring bitmap unchanged during a modification period of time. As previously mentioned, the modification period time may be specific for the access barring SIB.

### Abbreviations

eNB Evolved node B

CE Coverage Enhancement

FFS For Further Study

EPC Evolved Packet Core

SIB System Information Block

MIB Master Information Block

MTC Machine-Type Communications

LTE Long term evolution

SFN System frame number

UE User equipment

When using the word “comprise” or “comprising” it shall be interpreted as non-limiting, i.e. meaning “consist at least of”. Further, the word “a” or “an” should be understood to refer to “at least one” or to “one or more” if not explicitly stated that it refers to a “single” entity.

The embodiments herein are not limited to the above described preferred embodiments. Various alternatives, modifications and equivalents may be used.

1-34. (canceled)

35. A method performed by a wireless device for access control in a communications network, wherein the wireless device and a Radio Network Node (RNN) operate in the communications network, and wherein the method comprises:
receiving, from the RNN, a Master Information Block (MIB); and
determining whether or not access barring is active by checking an access barring indication in the received MIB.

36. The method of claim 35, wherein the access barring indication is an explicit indication comprising a bit or flag.

37. The method of claim 35, wherein the access barring indication is an implicit indication comprising a configuration identity.

38. The method of claim 35, wherein the method further comprises:
responsive to a determination that access barring is active, receiving, from the RNN, an access barring System Information Block (SIB).

39. The method of claim 38, wherein the method further comprises:
responsive to a determination that access barring is active, checking a value tag to determine whether or not the wireless device has up-to-date system information; and
responsive to a determination that the system information is not valid, re-acquiring the access barring System Information Block (SIB).

40. The method of claim 38, wherein the method further comprises:
determining, based on an access barring bitmap comprised in the access barring SIB, whether or not the wireless device belongs to a barred access class of wireless devices.

41. The method of claim 40, wherein the method further comprises:
responsive to a determination that the wireless device belongs to a barred access class of wireless devices, deferring from trying to access the RNN for a period of time.

42. The method of claim 41, wherein the period of time is dependent on a modification period of time that is specific for the access barring SIB.

43. The method of claim 42, wherein an access barring bitmap comprised in the access barring SIB is kept unchanged during the modification period of time.

44. A wireless device configured for access control in a communications network, wherein the wireless device comprises:
a wireless transmitter and receiver; and
processing circuitry operatively associated with the wireless transmitter and receiver, and configured to:
acquire a Master Information Block (MIB) broadcasted by a radio network node (RNN) in the communications network; and
determine whether or not access barring is active by checking an access barring indication in the acquired MIB.

45. The wireless device of claim 44, wherein the access barring indication is an explicit indication comprising a bit or a flag.

46. The wireless device of claim 44, wherein the access barring indication is an implicit indication comprising a configuration identity.

47. The wireless device of claim 44, wherein the processing circuitry is configured to:
responsive to a determination that access barring is active, acquire an access barring System Information Block (SIB).

48. The wireless device of claim 47, wherein the processing circuitry is configured to:
responsive to a determination that access barring is active, check a value tag to determine whether or not the wireless device has up-to-date system information; and
responsive to a determination that the system information is not valid, re-acquire the access barring SIB.

49. The wireless device of claim 47, wherein the processing circuitry is configured to:
determine, based on an access barring bitmap comprised in the access barring SIB, whether or not the wireless device belongs to a barred access class of wireless devices.

50. The wireless device of claim 49, wherein the processing circuitry is configured to:
responsive to a determination that the wireless device belongs to a barred access class of wireless devices, defer from trying to access the RNN for a period of time.

51. The wireless device of claim 50, wherein the period of time is dependent on a modification period of time that is specific for the access barring SIB.

52. The wireless device of claim 51, wherein an access barring bitmap comprised in the access barring SIB is kept unchanged during the modification period of time.

53. A method performed by a Radio Network Node (RNN), for access control in a communications network, wherein a wireless device and the RNN operate in the communications network, and wherein the method comprises:
responsive to a determination that access to the RNN is to be allowed, setting an access barring indication in a Master Information Block (MIB) to indicate a cell access permission;
responsive to a determination that access to the RNN is to be barred, setting the access barring indication in the MIB to indicate a cell access prohibition; and
broadcasting the MIB.

54. The method of claim 53, wherein the access barring indication is one of:
an implicit indication comprising a configuration identity; and
an explicit indication comprising a bit or a flag.

55. The method of claim 53, further comprising:
setting a value tag in the MIB to indicate a scheduling of an access barring System Information Block (SIB) within a first SIB.

56. The method of claim 55, further comprising:
responsive to a determination that access to the RNN is to be allowed, stopping broadcasting of an access barring bitmap in the access barring SIB; and
responsive to a determination that access to the RNN is to be barred, starting broadcasting of the access barring bitmap in the access barring SIB.

57. The method of claim 56, further comprising:
keeping the access barring bitmap unchanged during a modification period of time, which modification period time is specific for the access barring SIB.

58. A Radio Network Node (RNN) configured for access control in a communications network configured to operate in the communications network, wherein the RNN comprises:
a wireless transmitter; and
processing circuitry configured to:
set an access barring indication in a Master Information Block (MIB) to indicate a cell access permission responsive to a determination that access to the RNN is to be allowed;
set the access barring indication in the MIB to indicate a cell access prohibition responsive to a determination that access to the RNN is to be barred; and
broadcast the MIB via the wireless transmitter.

59. The RNN of claim 58, wherein the access barring indication is one of:
an implicit indication comprising a configuration identity; and
an explicit indication comprising a bit or a flag.

60. The RNN of claim 58, wherein the processing circuitry is configured to:
set a value tag in the MIB to indicate a scheduling of an access barring System Information Block (SIB) within a first SIB.

61. The RNN of claim 58, wherein the processing circuitry is configured to:
stop broadcasting an access barring bitmap, responsive to a determination that access to the RNN is to be allowed; and
start broadcasting the access barring bitmap, responsive to a determination that access to the RNN is to be barred.

62. The RNN of claim 61, wherein the processing circuitry is configured to:
keep the access barring bitmap unchanged during a modification period of time, which modification period time is specific for the access barring SIB.

63. A non-transitory computer readable storage medium storing a computer program for access control in a communications network, wherein a wireless device and a Radio Network Node (RNN) operate in the communications network, the computer program comprising instructions that, when executed on at least one processor of the wireless device, cause the wireless device to:
acquire a Master Information Block (MIB) broadcasted by the RNN; and
determine whether or not access barring is active by checking an access barring indication in the acquired MIB.

64. A non-transitory computer readable storage medium storing a computer program for access control in a communications network, wherein a wireless device and a Radio Network Node (RNN) operate in the communications network, the computer program comprising instructions that, when executed on at least one processor of the RNN, cause the RNN to:
set an access barring indication in a Master Information Block (MIB) to indicate a cell access permission responsive to a determination that access to the RNN is to be allowed;
set the access barring indication in the MIB to indicate a cell access prohibition responsive to a determination that access to the RNN is to be barred; and
broadcast the MIB.

65. A wireless device configured for access control in a communications network, wherein the wireless device comprises a processor and a memory, said memory containing instructions executable by said processor to cause said wireless device to:
receive, from a Radio Network Node (RNN), a Master Information Block (MIB); and
defer from trying to access the RNN for a period of time, responsive to a determination that an access barring indication comprised in the received MIB indicates access barring and responsive to a determination that the wireless device belongs to a barred access class.

66. A Radio Network Node (RNN) configured for access control in a communications network, wherein the RNN comprises a processor and a memory, said memory containing instructions executable by said processor to cause said RNN to:
set an access barring indication in a Master Information Block (MIB) to indicate access permission responsive to a determination that access to the RNN is to be allowed;
set the access barring indication in the MIB to indicate access barring responsive to a determination that access to the RNN is to be barred; and
transmit the MIB to the wireless device.

67. A wireless device configured for access control in a communications network, wherein the wireless device comprises:
a receiving module configured to receive, from a Radio Network Node (RNN), a Master Information Block (MIB); and
a determining module configured to determine to defer from trying to access the RNN for a period of time responsive to a determination that an access barring indication comprised in the received MIB indicates access barring and responsive to a determination that the wireless device is determined to belong to a barred access class.

68. A Radio Network Node (RNN) configured for access control in a communications network, wherein the RNN comprises:
a setting module configured to set an access barring indication in a Master Information Block (MIB) to indicate access permission responsive to a determination that access to the RNN is to be allowed;
wherein the setting module further is configured to set the access barring indication in the MIB to indicate access barring responsive to a determination that access to the RNN is to be barred; and
wherein the RNN further comprises a transmitting module configured to broadcast the MIB.
